(19) United States
(12) Patent Application Publication
(10) Pub. No.: US 2011/0262367 A1
(43) Pub. Date: Oct. 27, 2011

(54) INSECTICIDAL GASSING AGENT CONTAINING ACTIVE INGREDIENT IN THE FORM OF A GRANULATE

(76) Inventors: Johan Kijlstra, Odenthal (DE); Frank Rosenfeldt, Langenfeld (DE); Stephan Schüle, Hilden (DE); Ulrich Steffen, Monheim (DE)

(21) Appl. No.: 13/063,327

(22) PCT Filed: Sep. 8, 2009
(86) PCT No.: PCT/EP09/06503

§ 371 Date: Jul. 8, 2011

(30) Foreign Application Priority Data
Sep. 16, 2008 (EP) 08164383.5

(51) Int. Cl. A01N 25/20; A01P 7/04; D04H 1/64; A01N 25/08

(52) U.S. Cl. 424/40; 424/409; 264/128

(57) ABSTRACT

The present invention relates to novel insecticidal fumigants which are prepared using active substance granules, to the processes for the preparation of such fumigants and to their use for controlling harmful and/or nuisance insects.

The present invention relates to novel insecticidal fumigants which are prepared using active substance granules, to the processes for the preparation of such fumigants and to their use for controlling harmful and/or nuisance insects.

Combustible insecticidal fumigants have been known for a long time and are commercially available. They are prepared and sold for example as “mosquito coil” (or simply “coils”). It is possible to employ various insecticides, for example from the class of the pyrethroids, in these coils. In conventional coils, however, some of the active substances employed have the disadvantages that they, owing to chemico-physical parameters, tend to escape relatively rapidly, so that their shelf life is limited. An attempt to counteract the volatility of some pyrethroid is made by adding evaporation inhibitors, for example adipates or sebacates (for example EP 0 693 254); however, this is successful to a limited extent only. Furthermore, these coils are dried at lower temperatures in order to minimize such active substance losses during preparation.

There is therefore a need for improved combustible insecticidal fumigants with prolonged storage stability. Accordingly, the technical problem on which the present invention is based is to provide combustible insecticidal fumigants with a long shelf life and to provide processes for their preparation. This problem is solved by the fumigants according to the invention, which are distinguished by the fact that the insecticidal active substance is incorporated into the compositions in the form of granules.

The present invention therefore relates to novel combustible insecticidal fumigants which are prepared using active-substance-containing granules, to the processes for the preparation of such fumigants and to their use for controlling harmful and/or nuisance insects. Furthermore, the invention relates to the use of granules for the preparation of combustible insecticidal fumigants.

Surprisingly, it has been found that the combustible insecticidal fumigants according to the invention tend substantially less to lose active substance as the result of off-gassing than the predecessors described in the prior art. This makes it possible to realize a longer shelf life or a reduced use of active substance.

The present invention therefore relates to a combustible insecticidal fumigant, characterized in that it comprises an insecticide, granules as carrier material, and an evaporation inhibitor. Here, the insecticide and the evaporation inhibitor are present in the granules.

The preparation of the compositions according to the invention do not require any particular technical outlay. Rather, it is possible to continue to use existing apparatuses. Thus, the actual preparation process of the combustible insecticidal fumigants also differs in no way from the one used to date and known to the skilled worker. It merely differs from the prior art in the type of the formulation employed.

Although the compositions according to the invention are hereinbelow referred to as “coil” in some instances, the compositions will, of course, in no way have to take the form of spirals, but can be prepared in any shape and have the properties which are essential to the invention.

The insecticides which can be employed in the compositions according to the invention are all insecticides which are employed in coils which have already been described. Those which can preferably be employed are pyrethroids, for example acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrin (pyrethrum), eflusilana. Preferred are deltamethrin, beta-cyfluthrin, transfluthrin, resmethrin and metofluthrin. Especially preferred are transfluthrin and metofluthrin. Very especially preferred is transfluthrin.

Active-substance-containing granules are known from the prior art and can be prepared by the methods described therein. Methods which may be mentioned by way of example are the extrusion of granules and the coating of carrier materials by spraying or mixing with an active-substance-containing solution. Granules for the purposes of the present invention are considered to be particles with a mean particle size of from 50 to 800 μm, preferably from 100 to 500 μm, especially preferably from 125 to 400 μm.

Carriers which are suitable as carrier material (for example for spray-coating) are all commercially available porous carriers provided for this purpose, for example those based on cellulose (Biodac® 20/50, by Kadant Inc.), meerschaum (Sepiolith® 30/60) or pumice (porous volcanic rock).

The insecticide content, based on the granules present in the compositions according to the invention, may be varied within a wide range. It is typically 0.1 to 20% by weight, preferably 0.5 to 10% by weight, especially preferably 1 to 10% by weight and very especially preferably 2 to 5% by weight.

The compositions according to the invention additionally comprise an evaporation inhibitor. Suitable substances are all evaporation inhibitors described as such in the prior art, for example (poly)aromatic, but also acyclic hydrocarbons in pure form, but also present in mixtures. Preferred are diphenyl, diphenyl ether, o-, m-, p-terphenyl, mixtures of hydrogenated hydrocarbons, for example in their commercially available fauns, Diphyl THT®, Santotherm®, Therm S 900®, butyl stearate, butyl oleate, methyl acetyl ricinoleate, diethyl glycol distearate; Isopar V®, Exsol D140® (Exxon), butoxyethyl stearate, tetrahydrofurfuryl oleate, epoxymethyl stearate, epoxybutyl oleate and the like; dibasic aliphatic acid esters, for example didecyl adipate, di-2-ethylene adipate, dimethoxyethyl adipate, di-2-ethylene azelate, diisodecyl acetate, di-2-ethylhexyl sebacate, dibutyl sebacate, dioctyl malate, dioctyl fumarate and the like; aromatic carboxylic acid esters, for example diethyl glycol benzoate, trioctyl trimellitate, tri(2-ethylhexyl) trimesate and the like; carboxylic acid derivatives such as, for example, ureas, carbamic acids, carbamic esters and carboxamides such as, for example, N,N-dimethyloctanamides and N,N-dimethyldecanamides and their mixtures, propylene glycol esters and glycerol esters such as, for example, ricinoleic esters, polyethylene glycol derivatives such as, for example, diethylene glycol dibutyl ether, alkylsulfonic esters of phenol, inorganic acid esters, for example tricresyl phosphate, tri-2-ethylhexyl phosphate, tributyl phosphate and the like; phthalic esters, for example di-2-ethylhexyl phthalate, dibutyl phthalate, diisobutyl phthalate, dicyclohexyl phthalate and the like; citric esters, for example triethyl citrate, tributyl citrate, tributylacetyl citrate and the like. Especially preferred substances are those from the class of the adipates which are commercially available for example under the names Adimoll® (Lanxess AG), Plastomoll® (BASF AG), from the class of the polyadipates, which are commercially available for example under the name Ultramoll® (Lanxess AG), and from the class of the sebacates, which are commercially available for example under the name Synative® (Cognis GmbH).

In the case of a liquid evaporation inhibitor, the latter may be used for dissolving or suspending the insecticide and then sprayed onto the carrier.

It is preferred to prepare the insecticide-containing granules by dissolving the insecticide in the corresponding, preferably liquid, evaporation inhibitor and subsequently applying the mixture to the carrier material. The application is preferably carried out by spray application.

The evaporation inhibitor content, based on the granules present in the compositions according to the invention, can be varied within a wide range. The upper limit of the content is established by the fact that the flowability of the granules should be retained. Typically, it is 0.5 to 50% by weight, preferably 1 to 30% by weight, especially preferably 2 to 25% by weight and very especially preferably 5 to 20% by weight.

The present invention also relates to granules, containing carrier material, insecticide and evaporation inhibitor, the granules having particle sizes of from 50 μm to 800 μm.

The fumigants according to the invention are prepared by known methods, which are explained by way of example hereinbelow. In principle, any known preparation process can readily be modified so that it can be used for preparing compositions according to the invention.

To generate an adhesive action, starch or starch-like products of various origins are employed and are boiled in hot water or by means of steam. This generates a sticky paste which is only just flowable. The use of industrially produced, pregelatinized starch in powdered form is also possible in order to simplify the process. However, such products are very rarely employed, due to the higher costs. In works with a higher degree of mechanization, and for larger production batches, this process step is carried out in specialist kneaders.

The basic raw material of the fumigants are wood meals of different origins, according to what is available locally. Meals of tropical hardwoods and coconut shells in various mixing ratios give advantages both regarding the preparation and the product quality. The wood meal may be replaced by ground charcoal. This gives rise to black products, which do not require any further colorant. Large belt or paddle mixers are employed for preparing the mixture. The active-substance-containing granules, which are the special feature of the fumigants according to the invention, are also admixed to the wood meals in the desired quantity.

Frequently, coils, which are normally brown, are colored by adding colorant. Besides green colorant, a red colorant is also used in individual cases.

The wood meal mixture, adhesive and, if appropriate, color are finally combined in a mixing roll mill and everything is kneaded, mixed and rolled until the required homogeneity and consistency have been reached. The finished composition is then discharged into a storage container, from which the downstream, continuously operating belt extruder is supplied.

Using twin-screw extruders, the coil composition is extruded at a higher temperature to give a smooth extrudate approximately 5 mm thick and up to 20 cm wide. This extrudate is cut into pieces approximately 1.20 m in length, which pieces are supplied to a punching machine. Punches with different degrees of mechanization are being employed.

The products are dried for example in such a way that the punched products are manually placed on wire mesh or perforated plate hurdles, which are stacked on platform rack trucks. To dry the products, these platform rack trucks are then wheeled into drying rooms, where they are dried for 6-8 hours at 60° C.-70° C.

Highly-mechanized works operate continuously operating dryers, which immediately follow the punching machines and are charged automatically. The products are located in smallish hurdles which, in turn, hang in two continuous chains and are conveyed through the oven over several stories. The ovens may be up to 60 m long and 8 m in height and equipped with continuous chains up to 600 m in length. The drying temperature is, again, 60° -70° C., and the residence time of the coils is 3-4 hours.

Drying of the coils is complete when the moisture content is 6-8%.

The present invention relates to a process for the preparation of the fumigants according to the invention, characterized in that, first, wood meal is mixed with the insecticide-containing granules and, subsequently, adhesive in the faun of starch or starch-like products and, if appropriate, color are added, and everything is kneaded, mixed and rolled and the resulting composition is extruded and dried.

Depending on the active substance used, the fumigants according to the invention may be used against different insects. They may be, for example:

From the order Scorpionidea, for example Buthus occitanus.

From the order Acarina, for example Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order Araneae, for example Aviculariidae, Araneidae.

From the order Opiliones, for example Pseudoscorpiones chelifer, Pseudoscorpiones cheiridium, Opiliones phalangium.

From the order Isopoda, for example Oniscus asellus, Porcellio scaber.

From the order Diplopoda, for example Blaniulus guttulatus, Polydesmus spp. From the order Chilopoda, for example Geophilus spp.

From the order Zygentoma, for example Ctenolepisma spp., Lepisma saccharina, Lepismodes inquilinus.

From the order Blattaria, for example Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order Saltatoria, for example Acheta domesticus.

From the order Dermaptera, for example Forficula auricularia.

From the order Isoptera, for example Kalotermes spp., Reticulitermes spp.

From the order Psocoptera, for example Lepinatus spp., Liposcelis spp.

From the order Coleoptera, for example Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order Diptera, for example Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order Lepidoptera, for example Achroia grisella, Galleria mellonella, Plodia interpunctella, Tinea cloacella, Tinea pellionella, Tineola bisselliella.

From the order Siphonaptera, for example Ctenocephalides canis, Ctenocephalides felis, Pulex irritans, Tunga penetrans, Xenopsylla cheopis.

From the order Hymenoptera, for example Camponotus herculeanus, Lasius fuliginosus, Lasius niger, Lasius umbratus, Monomorium pharaonis, Paravespula spp., Tetramorium caespitum.

From the order Anoplura, for example Pediculus humanus capitis, Pediculus humanus corporis, Pemphigus spp., Phylloera vastatrix, Phthirus pubis.

From the order Heteroptera, for example Cimex hemipterus, Cimex lectularius, Rhodinus prolixus, Triatoma infestans.

Preferred is the use for controlling insects from the class Diptera, for example Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

The fumigants according to the invention are used in a known manner by lighting.

### PREPARATION EXAMPLES

### Example A

Tranfluthrin was dissolved in adipate (Plastomoll® DOA) at a concentration of 20% by weight. The resulting solution was applied to granules (Sepiolith® 30/60) by spraying in an amount of 15% by weight.

### Example B

Analogously to Example A, granules with 3% by weight of transfluthrin, 12% by weight of Isopar® M and 85% by weight Biodac® 20/50 were prepared.

### Example C

Analogously to Example B, granules with 3% by weight of transfluthrin, 12% by weight of Synative® ES DEHS and 85% by weight of Biodac® 20/50 were prepared.

### Example D

Analogously to Example A, granules with 3% by weight of transfluthrin, 12% by weight of Plastomoll® DOA and 85% by weight of Sepiolith® 30/60 were prepared.

### Example E

Analogously to Example A, granules with 5% by weight of transfluthrin, 10% by weight of Plastomoll® DOA and 85% of Biodac ® 20/50 were prepared.

### Example F

Analogously to Example A, granules with 3% by weight of transfluthrin, 10% by weight of Plastomoll® DOA and 85% by weight of pumice (particle size 0.3 to 1 mm) were prepared.

### Example G

Analogously to Example A, granules with 5% by weight of transfluthrin, 10% by weight of Plastomoll® DOA and 85% by weight of pumice (particle size 90 to 600 μm) were prepared.

### Example 1

To prepare active-substance-containing granules, previously prepared solutions of transfluthrin in various solvents were applied, at room temperature, to the absorptive carrier material Sepiolith 30/60 in a rotating coating machine. This gave flowable granules with a homogeneous active substance distribution, whose composition is shown in table 1.

TABLE 1
Composition of the transfluthrin granules

| No. | GR1 | GR2 | GR3 |
|---|---|---|---|
| Component | % | % | % |
| Transfluthrin | 3.0 | 3.0 | 3.0 |
| Adimoll ® BO (Lanxess) | 12.0 | 6.0 | |
| Ultramoll ® IV (Lanxess) | | 6.0 | |
| Plastomoll ® DOA(BASF) | | | 12.0 |
| Sepiolite ® 30/60 (Tolsa) | 85.0 | 85.0 | 85.0 |

To prepare active-substance-containing coils at 70° in a mixer-kneader (Becolabmini, Becomix), 92 g of a starch powder and 270 g of a coconut powder were mixed for 10 minutes at 70° together with 3.9 g of one of the abovementioned active substance granules. Thereafter, 599 g of hot water (90-100° C.) together with 0.3 g of sodium benzoate were added, and everything was kneaded for a further 20 minutes until a homogeneous paste had been obtained. This paste was extruded in a hand-operated tabletop pressure filler (Dick) to give coils with a diameter of 6 mm, which were dried for 7 h at 60° C.

The active substance content of these finished coils was both directly after production and after open storage in a 25 m³ controlled-environment room at 40° C. The results are shown in table 2.

TABLE 2
Experimental active substance content of the transfluthrin-containing
coils (in % by weight), prepared with the granules GR1-GR3.

| | | Initial value | after 24 h | after 72 h |
|---|---|---|---|---|
| coil | based on | % | % | % |
| C1 | GR1 | 0.036 | 0.036 | 0.034 |
| C2 | GR2 | 0.035 | 0.035 | 0.033 |
| C3 | GR3 | 0.033 | 0.033 | 0.032 |

A minor loss of 3-6% active substance was observed only after open storage at 40° C. for 72 hours.
Wood and coconut meals: particle size: 80 mesh (0.180 mm), tolerance: +/−10%, water content no more than 13%
Bulk density: wood meal 0.23+/−2 g/ccm, coconut meal 0.48 g/ccm
Starch: viscosity min 60 000 cps (Brookfield HBT 230 V Spindel 2 0.3 rpm, 45 g in 450 ml water, 95° C.)
Gum Powder (wood adhesive powder): viscosity min 3 500 cps (Brookfield HBT 230 V Spindel 3; 0.3 rpm, 15 g in 400 ml water)

### Comparative example

To prepare active-substance-containing granules, a procedure analogous to example 1 was followed, only that 0.59 g of an emulsifiable concentrate (transfluthrin EC 20, corresponds to “prior art”) was employed as active substance source instead of 3.9 g of granules (content 3%). The composition of this concentrate is shown in table 3.

TABLE 3
Composition of transfluthrin EC 20

| No. | EC1 |
|---|---|
| Component | % |
| Transfluthrin | 20.0 |
| Emulsogen ® 3510 (Clariant) | 4.0 |
| Tanemul ® 1371A (Tanatex) | 6.0 |
| Adimoll ® DB (Lanxess) | 70.0 |

The active substance content of the coils was both directly after the preparation and after open storage at 40° C. in a 25 m³ controlled-environment room. The results are shown in table 4.

TABLE 4
Experimental active substance content of the transfluthrin-
containing coils (in %), prepared with the transfluthrin EC 20.

| | | Initial value | after 24 h | after 72 h |
|---|---|---|---|---|
| coil | based on | % | % | % |
| C1 | EC1 | 0.037 | 0.034 | 0.033 |

In contrast to the coils in example 1, a significant loss of active substance during storage was observed (8% after 24 h and 11% after 72 h).

1. A combustible insecticidal fumigant, comprising an insecticide, granules as carrier material, and an evaporation inhibitor.

2. The combustible insecticidal fumigant as claimed in claim 1, wherein the granules are particles with a mean particle size of at least 50 μm.

3. The combustible insecticidal fumigant as claimed in claim 1, wherein the granules as carrier material are porous and based on cellulose, meerschaum, or pumice.

4. The combustible insecticidal fumigant as claimed in claim 1, wherein the evaporation inhibitor is from the group of adipates, polyadipates, or sebacates.

5. A process for preparing the combustible insecticidal fumigants as claimed in claim 1, wherein, first, wood meal is mixed with the insecticide-containing granules and, subsequently, adhesive in the form of starch or starch-like products and, if appropriate, color are added, and everything is kneaded, mixed and rolled and the resulting composition is extruded and dried.

6. Granules, containing carrier material, insecticide, and evaporation inhibitor, the granules having particle sizes of from 50 μm in to 800 μm.

7. (canceled)

8. A combustible insecticidal fumigant, comprising insecticide that is in the form of granules.

9. A combustible insecticidal fumigant, obtainable by using active-substance-containing granules during the preparation.

10. (canceled)

11. A process for preparing a combustible insecticidal fumigant, wherein the insecticidal active substance is added in the form of granules.

12. The combustible insecticidal fumigant in claim 9, wherein the active substance in the granule is an insecticide.
